(19) United States
(12) Patent Application Publication
(10) Pub. No.: US 2021/0384565 A1
(43) Pub. Date: Dec. 9, 2021

(54) ENERGY STORAGE DEVICE TEMPERATURE CONTROL METHOD AND APPARATUS

(71) Applicant: HUAWEI TECHNOLOGIES CO., LTD., Shenzhen (CN)

(72) Inventors: Jianghui YANG, Dongguan (CN); Jun CHEN, Dongguan (CN); Quanming LI, Dongguan (CN)

(21) Appl. No.: 17/402,778

(22) Filed: Aug. 16, 2021

Related U.S. Application Data
(63) Continuation of application No. PCT/CN2020/071428, filed on Jan. 10, 2020.

(30) Foreign Application Priority Data
Apr. 15, 2019 (CN) 201910299422.6

(51) Int. Cl. H01M 10/633; H02S 10/20; H01M 10/613; H01M 10/48; H01M 10/46; G01K 3/00; G05B 15/02

(52) U.S. Cl. CPC H01M 10/633; H02S 10/20; H01M 10/613; G05B 15/02; H01M 10/465; G01K 3/005; H01M 10/486

(57) ABSTRACT

An energy storage device temperature control method is provided, to reduce a waste of electric energy. The method includes: obtaining an idle electric energy yield of a photovoltaic power generation system and a battery temperature of an energy storage device, where the photovoltaic power generation system includes a photovoltaic array, the energy storage device, and a load, the energy storage device includes a refrigerating device and a battery, and the idle electric energy yield is a difference between an electric energy yield of the photovoltaic array and an electric energy consumption amount of the energy storage device and the load; and determining a refrigeration temperature of the refrigerating device based on the idle electric energy yield and the battery temperature, where the refrigerating device is used to control a temperature of the battery.

### CROSS-REFERENCE TO RELATED APPLICATIONS

This application is a continuation of International Application No. PCT/CN2020/071428, filed on Jan. 10, 2020, which claims priority to Chinese Patent Application No. 201910299422.6, filed on Apr. 15, 2019. The disclosures of the aforementioned applications are hereby incorporated by reference in their entireties.

### TECHNICAL FIELD

This application relates to the field of temperature controlling, and in particular, to an energy storage device temperature control method and apparatus.

### BACKGROUND

A photovoltaic power generation system mainly includes a photovoltaic array, an energy storage device, an energy conversion apparatus, and a load. In daytime, the photovoltaic array uses sunlight to generate electricity, and generated electric energy is transferred, by using the energy conversion apparatus, to the load for use or is stored in the energy storage device. The photovoltaic array cannot generate electricity at night, and the energy storage device outputs electric energy to the load for use. When an electric energy yield of the photovoltaic power generation system exceeds an amount of electric energy needed by the load and the energy storage device, in other words, there is an idle electric energy yield, an electric energy yield of the photovoltaic array is limited, in other words, a light discarding phenomenon occurs.

Generally, a battery in the energy storage device is a lead-acid battery or a lithium battery, and a high temperature affects a service life of the battery. To extend the service life of the battery, generally, a refrigerating device is used to control a battery temperature. In the prior art, the battery temperature is monitored, and if the battery temperature exceeds a preset temperature threshold, the refrigerating device is turned on, or if the battery temperature is less than the temperature threshold, the refrigerating device is turned off.

In the prior art, when the temperature of the battery in the energy storage device is greater than the preset temperature threshold, the refrigerating device is turned on, or when the temperature is less than the temperature threshold, the refrigerating device is turned off. If there is no idle electric energy yield in the photovoltaic power generation system when the refrigerating device is turned on, more electric energy may be consumed. If there is an idle electric energy yield in the photovoltaic power generation system when the refrigerating device is turned off, all of the idle electric energy yield is discarded, resulting in a waste of electric energy.

### SUMMARY

Embodiments of this application provide an energy storage device temperature control method, to reduce waste of electric energy.

A first aspect of an embodiments of this application provides an energy storage device temperature control method, including: obtaining an idle electric energy yield of a photovoltaic power generation system and a battery temperature of an energy storage device, where the photovoltaic power generation system includes a photovoltaic array, the energy storage device, and a load, the energy storage device includes a refrigerating device and a battery, and the idle electric energy yield is a difference between an electric energy yield of the photovoltaic array and an electric energy consumption amount of the energy storage device and the load; and determining a refrigeration temperature of the refrigerating device based on the idle electric energy yield and the battery temperature, where the refrigerating device is used to control a temperature of the battery.

The photovoltaic power generation system includes the photovoltaic array, the energy storage device, and the load, and the energy storage device includes the refrigerating device and the battery. In the photovoltaic power generation system, the photovoltaic array may generate electricity, the load consumes electric energy, and the energy storage device may store electric energy. When an electric energy yield is greater than an amount of consumed electric energy and stored electric energy, the photovoltaic power generation system has the idle electric energy yield, and generally, the idle electric energy yield is discarded, leading to a waste. The battery needs to work in an appropriate temperature range. When the temperature is excessively high, a service life of the battery may decrease. Therefore, the battery needs to be cooled by using the refrigerating device. In the method provided in this embodiment of this application, first, the idle electric energy yield of the photovoltaic power generation system and the battery temperature of the energy storage device are obtained, and then the refrigeration temperature of the refrigerating device is comprehensively determined based on the idle electric energy yield of the photovoltaic power generation system and the battery temperature of the energy storage device, to more fully utilize electric energy compared with a case of determining, based only on a battery temperature, whether to perform refrigeration.

In a possible implementation of the first aspect, the determining a refrigeration temperature of the refrigerating device based on the idle electric energy yield and the battery temperature includes: if the idle electric energy yield is greater than zero, determining that the refrigeration temperature is a first target temperature, or determining, based on the battery temperature of the energy storage device and/or the idle electric energy yield, that the refrigeration temperature is the first target temperature; or if the idle electric energy yield is less than or equal to zero, determining, based on the battery temperature, that the refrigeration temperature is a second target temperature or turning off the refrigerating device based on the battery temperature, where the second target temperature is greater than the first target temperature.

According to the energy storage device temperature control method in this embodiment of this application, when the idle electric energy yield is greater than zero, a relatively low refrigeration temperature is set, to fully utilize idle electric energy, and reduce a waste of electric energy.

In a possible implementation of the first aspect, the determining, based on the battery temperature of the energy storage device and/or the idle electric energy yield, that the refrigeration temperature is a first target temperature includes: determining, based on the idle electric energy yield, that the refrigeration temperature is the first target temperature, where the idle electric energy yield is negatively correlated with the first target temperature; or determining, based on the battery temperature, that the refrigeration temperature is the first target temperature, where the battery temperature is negatively correlated with the first target temperature; or determining, based on the battery temperature and the idle electric energy yield, that the refrigeration temperature is the first target temperature, where the idle electric energy yield is negatively correlated with the first target temperature, and the battery temperature is negatively correlated with the first target temperature.

According to the energy storage device temperature control method in this embodiment of this application, three specific manners of determining, based on the battery temperature of the energy storage device and/or the idle electric energy yield when there is the idle electric energy yield, that the refrigeration temperature is the first target temperature are provided, to improve solution implementation diversity. A higher idle electric energy yield indicates a lower refrigeration temperature, so that a waste of electric energy can be reduced. A higher battery temperature indicates a lower refrigeration temperature, so that idle electric energy can be utilized, to quickly decrease the battery temperature and reduce a waste of electric energy.

In a possible implementation of the first aspect, the determining, based on the battery temperature of the energy storage device and/or the idle electric energy yield, that the refrigeration temperature is a first target temperature includes: if the idle electric energy yield is greater than zero and less than a preset first threshold, determining that the refrigeration temperature is a third target temperature, where the first threshold is greater than zero, and the third target temperature is less than the second target temperature; or if the idle electric energy yield is greater than or equal to the first threshold, determining that the refrigeration temperature is a fourth target temperature, where the fourth target temperature is less than the third target temperature.

According to the energy storage device temperature control method in this embodiment of this application, when the idle electric energy yield is a relatively high interval, the refrigeration temperature is relatively low, to fully utilize idle electric energy.

In a possible implementation of the first aspect, the determining, based on the battery temperature of the energy storage device and/or the idle electric energy yield, that the refrigeration temperature is a first target temperature includes: if the battery temperature is greater than or equal to a preset first high-temperature threshold and less than a preset second high-temperature threshold, determining that the refrigeration temperature is a fifth target temperature, where the second high-temperature threshold is greater than the first high-temperature threshold; or if the battery temperature is greater than the second high-temperature threshold, determining that the refrigeration temperature is a sixth target temperature, where the sixth target temperature is less than the fifth target temperature.

According to the energy storage device temperature control method in this embodiment of this application, when the battery temperature is in a relatively high interval, the refrigeration temperature is relatively low, so that idle electric energy can be utilized, to quickly decrease the battery temperature, and extend a service life of the battery.

In a possible implementation of the first aspect, the determining, based on the battery temperature, that the refrigeration temperature is a second target temperature or turning off the refrigerating device based on the battery temperature includes: if the battery temperature is greater than or equal to a preset high-temperature threshold, determining that the refrigeration temperature is the second target temperature; or if the battery temperature is less than the high-temperature threshold, turning off the refrigerating device.

According to the energy storage device temperature control method in this embodiment of this application, when there is no idle electric energy yield, and when the battery temperature is less than the high-temperature threshold, the refrigerating device is turned off to reduce electric energy consumption, or when the battery temperature is greater than or equal to the high-temperature threshold, the refrigeration temperature is the second target temperature, and the second target temperature is greater than the first target temperature that is set as the refrigeration temperature when there is the idle electric energy yield, to reduce electric energy consumption.

In a possible implementation of the first aspect, the determining that the refrigeration temperature is the second target temperature includes: determining, based on the battery temperature, that the refrigeration temperature is the second target temperature, where the second target temperature is positively correlated with the battery temperature.

According to the energy storage device temperature control method in this embodiment of this application, when the battery temperature is greater than or equal to the preset high-temperature threshold and there is no idle electric energy yield, a higher battery temperature indicates a higher refrigeration temperature, to reduce electric energy consumption.

In a possible implementation of the first aspect, the determining that the refrigeration temperature is the second target temperature includes: if the battery temperature is greater than or equal to a preset third high-temperature threshold and less than a preset fourth high-temperature threshold, determining that the refrigeration temperature is a seventh target temperature, where the fourth high-temperature threshold is greater than the third high-temperature threshold, and the seventh target temperature is greater than the first target temperature; or if the battery temperature is greater than or equal to the fourth high-temperature threshold, determining that the refrigeration temperature is an eighth target temperature, where the eighth target temperature is greater than the seventh target temperature.

According to the energy storage device temperature control method in this embodiment of this application, when the battery temperature is greater than or equal to the preset high-temperature threshold and there is no idle electric energy yield, when the battery temperature belongs to a relatively high temperature interval, the refrigeration temperature is relatively high, to reduce electric energy consumption.

In a possible implementation of the first aspect, the method further includes: if the battery temperature is less than or equal to a preset low-temperature threshold, turning off the refrigerating device, where the low-temperature threshold is less than any one of the first high-temperature threshold, the third high-temperature threshold, and the high-temperature threshold.

According to energy storage device temperature control method in this embodiment of this application, when the battery temperature is less than the preset low-temperature threshold, the refrigerating device is turned off, to reduce electric energy consumption, and improve solution implementation integrity.

In a possible implementation of the first aspect, the obtaining an idle electric energy yield of a photovoltaic power generation system includes: obtaining a photovoltaic generated power and a consumed power, where the consumed power includes a consumed power of the load and a charging power of the battery; and determining the idle electric energy yield based on a difference between the photovoltaic generated power and the consumed power.

According to energy storage device temperature control method in this embodiment of this application, a specific implementation of obtaining the idle electric energy yield of the photovoltaic power generation system is provided, to improve feasibility of the solution.

A second aspect of the embodiments of this application provides an energy storage device temperature control apparatus, including: an obtaining unit, configured to obtain an idle electric energy yield of a photovoltaic power generation system and a battery temperature of an energy storage device, where the photovoltaic power generation system includes a photovoltaic array, the energy storage device, and a load, the energy storage device includes a refrigerating device and a battery, and the idle electric energy yield is a difference between an electric energy yield of the photovoltaic array and an electric energy consumption amount of the energy storage device and the load; and a determining unit, configured to determine a refrigeration temperature of the refrigerating device based on the idle electric energy yield and the battery temperature, where the refrigerating device is used to control a temperature of the battery.

In a possible implementation of the second aspect, the determining unit is configured to: if the idle electric energy yield is greater than zero, determine that the refrigeration temperature is a first target temperature, or determine, based on the battery temperature of the energy storage device and/or the idle electric energy yield, that the refrigeration temperature is the first target temperature; or if the idle electric energy yield is less than or equal to zero, determine, based on the battery temperature, that the refrigeration temperature is a second target temperature or turn off the refrigerating device based on the battery temperature, where the second target temperature is greater than the first target temperature.

In a possible implementation of the second aspect, the determining unit is configured to: determine, based on the idle electric energy yield, that the refrigeration temperature is the first target temperature, where the idle electric energy yield is negatively correlated with the first target temperature; or determine, based on the battery temperature, that the refrigeration temperature is the first target temperature, where the battery temperature is negatively correlated with the first target temperature; or determine, based on the battery temperature and the idle electric energy yield, that the refrigeration temperature is the first target temperature, where the idle electric energy yield is negatively correlated with the first target temperature, and the battery temperature is negatively correlated with the first target temperature.

In a possible implementation of the second aspect, the determining unit is configured to: if the idle electric energy yield is greater than zero and less than a preset first threshold, determine that the refrigeration temperature is a third target temperature, where the first threshold is greater than zero, and the third target temperature is less than the second target temperature; or if the idle electric energy yield is greater than or equal to the first threshold, determine that the refrigeration temperature is a fourth target temperature, where the fourth target temperature is less than the third target temperature.

In a possible implementation of the second aspect, the determining unit is configured to: if the battery temperature is greater than or equal to a preset first high-temperature threshold and less than a preset second high-temperature threshold, determine that the refrigeration temperature is a fifth target temperature, where the second high-temperature threshold is greater than the first high-temperature threshold; or if the battery temperature is greater than the second high-temperature threshold, determine that the refrigeration temperature is a sixth target temperature, where the sixth target temperature is less than the fifth target temperature.

In a possible implementation of the second aspect, the determining unit is configured to: if the battery temperature is greater than or equal to a preset high-temperature threshold, determine that the refrigeration temperature is the second target temperature; or if the battery temperature is less than the high-temperature threshold, turn off the refrigerating device.

In a possible implementation of the second aspect, the determining unit is configured to determine, based on the battery temperature, that the refrigeration temperature is the second target temperature, where the second target temperature is positively correlated with the battery temperature.

In a possible implementation of the second aspect, the determining unit is configured to: if the battery temperature is greater than or equal to a preset third high-temperature threshold and less than a preset fourth high-temperature threshold, determine that the refrigeration temperature is a seventh target temperature, where the fourth high-temperature threshold is greater than the third high-temperature threshold, and the seventh target temperature is greater than the first target temperature; or if the battery temperature is greater than or equal to the fourth high-temperature threshold, determine that the refrigeration temperature is an eighth target temperature, where the eighth target temperature is greater than the seventh target temperature.

In a possible implementation of the second aspect, the apparatus further includes: a turn-off unit, configured to: if the battery temperature is less than or equal to a preset low-temperature threshold, turn off the refrigerating device, where the low-temperature threshold is less than any one of the first high-temperature threshold, the third high-temperature threshold, and the high-temperature threshold.

In a possible implementation of the second aspect, the obtaining unit is configured to obtain a photovoltaic generated power and a consumed power, where the consumed power includes a consumed power of the load and a charging power of the battery; and the determining unit is further configured to determine the idle electric energy yield based on a difference between the photovoltaic generated power and the consumed power.

A third aspect of the embodiments of this application provides an energy storage device temperature control apparatus, including a processor and an input/output device, where the input/output device is configured to transmit data, and the processor is configured to perform the method in the first aspect and the implementations of the first aspect.

A fourth aspect of the embodiments of this application provides a computer program product, where the computer program product includes instructions, and when the instructions are run on a computer, the computer is enabled to perform the method in the first aspect and the implementations of the first aspect.

A fifth aspect of the embodiments of this application provides a computer readable storage medium, where the computer readable storage medium stores instructions, and when the instructions are run on a computer, the method in the first aspect of the embodiments of this application and the implementations of the first aspect is performed.

A sixth aspect of the embodiments of this application provides a photovoltaic power generation system, including the energy storage device temperature control apparatus in the second aspect.

It can be learned from the foregoing technical solutions that the embodiments of this application have the following advantages:

In the solutions provided in the embodiments of this application, the energy storage device can comprehensively determine the refrigeration temperature based on the battery temperature and the idle electric energy yield, to more fully utilize electric energy compared with a case of determining, based only on a battery temperature, whether to perform refrigeration.

### BRIEF DESCRIPTION OF DRAWINGS

FIG. 1 is a schematic architectural diagram of a micro-grid;

FIG. 2 is a schematic diagram of an energy storage device temperature control method according to an embodiment of this application;

FIG. 3 is a schematic diagram of an energy storage device temperature control method according to an embodiment of this application;

FIG. 4 is a schematic diagram of an energy storage device temperature control method according to an embodiment of this application;

FIG. 5 is a schematic diagram of an energy storage device temperature control method according to an embodiment of this application;

FIG. 6 is a schematic diagram of an energy storage device temperature control method according to an embodiment of this application;

FIG. 7 is a schematic diagram of an energy storage device temperature control method according to an embodiment of this application;

FIG. 8 is a schematic diagram of an energy storage device temperature control method according to an embodiment of this application;

FIG. 9 is a schematic diagram of an energy storage device temperature control apparatus according to an embodiment of this application; and

FIG. 10 is a schematic diagram of an energy storage device temperature control apparatus according to an embodiment of this application.

### DESCRIPTION OF EMBODIMENTS

Embodiments of this application provide an energy storage device temperature control method to determine a refrigeration temperature based on an idle electric energy yield, so that electric energy can be more fully utilized.

A photovoltaic power generation system mainly includes a photovoltaic array, an energy storage device, an energy conversion apparatus, and a load. In daytime, the photovoltaic array uses sunlight to generate electricity, and generated electric energy is transferred, by using the energy conversion apparatus, to the load for use or is stored in the energy storage device. The photovoltaic array cannot generate electricity at night, and the energy storage device outputs electric energy to the load for use. When an electric energy yield of the photovoltaic power generation system exceeds an amount of electric energy needed by the load and the energy storage device, in other words, there is an idle electric energy yield, an electric energy yield of the photovoltaic array is limited, in other words, a light discarding phenomenon occurs. The energy storage device includes a refrigerating device and one or more battery modules. The battery modules each generally includes a lead-acid battery or a lithium battery, and a service life of the battery decreases as the temperature increases. To extend the service life of the battery, generally, an air conditioner is used to control a temperature of a battery energy storage cabinet.

The energy storage device temperature control method in the embodiments of this application is applied to a photovoltaic power generation system, including various scenarios including a photovoltaic power generation apparatus. An application scenario is not limited in the embodiments of this application. The following provides description by using a micro-grid as an example.

FIG. 1 is a schematic architectural diagram of a micro-grid according to some embodiments.

The micro-grid is a small power generation and distribution system including a distributed power supply, an energy storage device, an energy conversion apparatus, and a load. A monitor, a protection device, a central control unit and the like that are not shown in the figure may also be included in the micro-grid. The micro-grid is mainly applied to other areas without grids, for example, a remote village and an island. The distributed power supply may, for example, include a photovoltaic array and a diesel generator. Because power generation costs of the photovoltaic array are less than power generation costs of the diesel generator, in actual application of the micro-grid, generally, the photovoltaic array is primarily used for power generation with assistance of the diesel generator. Electric energy generated by the distributed power supply is transferred, by using the energy conversion apparatus, namely, a micro-grid inverter, to the load for use or is stored in the energy storage device. The load may be a power consuming device in an area such as, for example, a residential quarter, a shop, a hospital, or a school. The energy storage device may be battery energy storage cabinets in various forms, for example, a board room or a container. The battery energy storage cabinet includes one or more batteries and a refrigerating device. The refrigerating device may be a device having a refrigeration capability, for example, an air conditioner or a semiconductor thermoelectric cooler (TEC), and is configured to control a temperature of the battery energy storage cabinet to be within an appropriate range, to extend a service life of the battery.

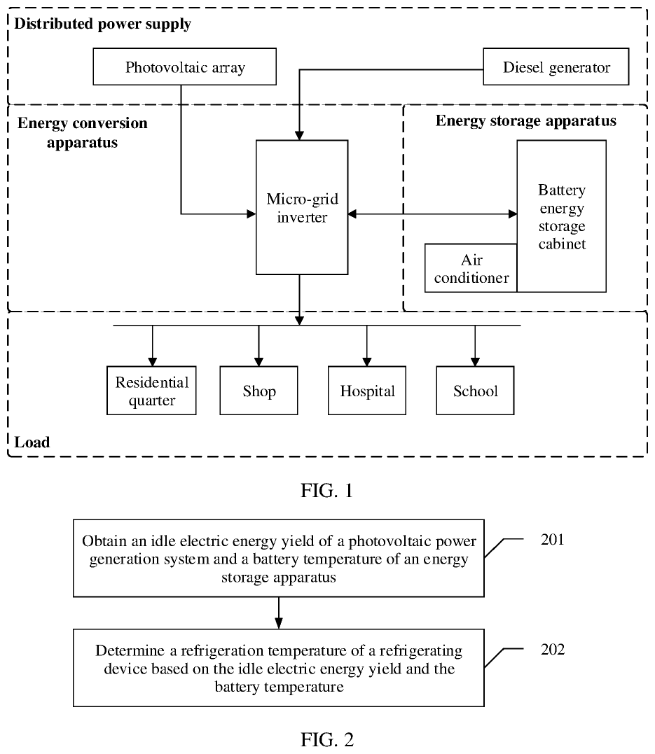

Based on the architecture of the micro-grid shown in FIG. 1, FIG. 2 is a schematic diagram of an energy storage device temperature control method according to an embodiment of this application.

201. Obtain an idle electric energy yield of a photovoltaic power generation system and a battery temperature of an energy storage device.

Electric energy generated by the photovoltaic power generation system needs to be stored in the energy storage device, the energy storage device includes one or more batteries, and the battery temperature may be collected by using a temperature sensor.

A photovoltaic array converts solar energy into electric energy, a part of the electric energy is supplied to a load for use, and another part of the electric energy is stored in the energy storage device. The idle electric energy yield is a current idle electric energy yield of the photovoltaic power generation system. The idle electric energy yield may be calculated by using a difference between an electric energy yield of the photovoltaic array and an electric energy consumption amount of the system. The electric energy consumption amount of the system includes an electric energy consumption amount of a load and an electric energy consumption amount of the energy storage device, and the electric energy consumption amount of the energy storage device includes an amount of charging power of the battery and an electric energy consumption amount of an air conditioner. The idle electric energy yield is a difference between the electric energy yield of the photovoltaic array and the electric energy consumption amount of the energy storage device and the load. The electric energy yield of the photovoltaic array, the electric energy consumption amount of the load, and the electric energy consumption amount of the energy storage device need to be obtained, to obtain the idle electric energy yield of the photovoltaic power generation system.

Optionally, the electric energy yield of the photovoltaic array may be estimated based on light intensity, or measured by using an electricity meter. This is not limited herein.

Optionally, the idle electric energy yield may be measured by using an idle generated power. Specifically, a generated power of the photovoltaic array, a consumed power of the load, and a consumed power of the energy storage device are obtained, and the consumed power of the load and the consumed power of the energy storage device are subtracted from the generated power of the photovoltaic array, to obtain the idle generated power.

Optionally, the photovoltaic power generation system may periodically obtain the battery temperature and the idle electric energy yield based on preset duration.

202. Determine a refrigeration temperature of a refrigerating device based on the idle electric energy yield and the battery temperature.

After the current battery temperature and idle electric energy yield are obtained, the refrigeration temperature of the refrigerating device in the energy storage device may be comprehensively determined based on the battery temperature and the idle electric energy yield.

There are a plurality of methods for comprehensively determining the refrigeration temperature based on the battery temperature and the idle electric energy yield. This is not limited herein.

It may be understood that when the idle electric energy yield is less than or equal to zero, the refrigeration temperature may be positively correlated with the battery temperature, to save electric energy. When the idle electric energy yield is greater than zero, a condition of turning on the refrigerating device may be lowered, or a lower refrigeration temperature may be determined, to reduce a waste of electric energy.

Optionally, when the battery temperature is within a preset temperature range, if the idle electric energy yield is greater than zero, it is determined that the refrigeration temperature is a preset target temperature, or if the idle electric energy yield is less than or equal to zero, the refrigerating device is turned off.

Optionally, when the battery temperature is within a preset temperature range, if the idle electric energy yield is greater than zero, it is determined that the refrigeration temperature is a preset first target temperature, or if there is no idle electric energy yield, it is determined that the refrigeration temperature is a preset second target temperature, where the second target temperature is greater than the first target temperature.

According to the energy storage device temperature control method in this embodiment of this application, the refrigeration temperature is determined based on both the battery temperature and the current idle electric energy yield, to more fully utilize electric energy compared with a case of determining, based only on a battery temperature, whether to perform refrigeration.

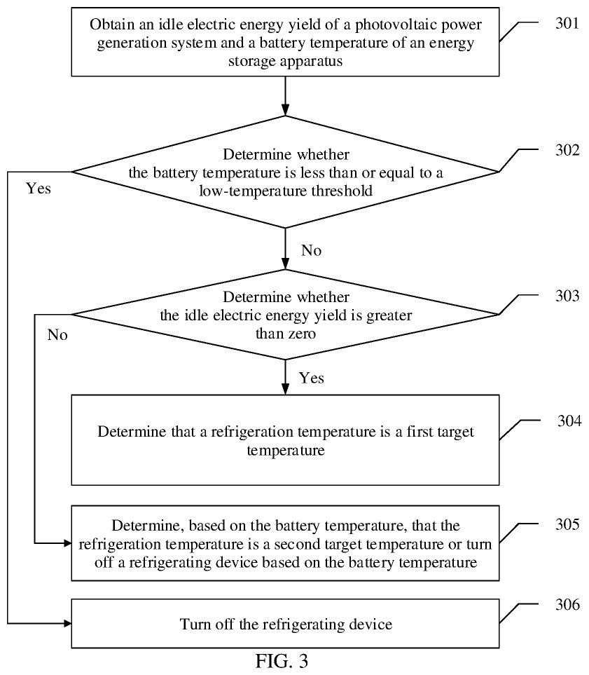

Based on the architecture of the micro-grid shown in FIG. 1, FIG. 3 is a schematic diagram of an energy storage device temperature control method according to an embodiment of this application.

301. Obtain an idle electric energy yield of a photovoltaic power generation system and a battery temperature of an energy storage device.

Electric energy generated by a photovoltaic array needs to be stored in a battery in the energy storage device, and the battery needs to work in an appropriate temperature range, to extend a service life. The battery temperature may be collected by using a temperature sensor in the energy storage device.

For example, an operating temperature of the battery may range from 10 degrees Celsius (° C.) to 30° C. When the battery temperature is greater than 30° C., the service life of the battery decreases as the temperature increases.

The idle electric energy yield is a current idle electric energy yield of the photovoltaic power generation system, and may be calculated by using a difference between an electric energy yield of the photovoltaic array and an electric energy consumption amount of the system. The electric energy consumption amount of the system includes an electric energy consumption amount of a load and an electric energy consumption amount of the energy storage device, and the electric energy consumption amount of the energy storage device includes an amount of charging power of the battery and an electric energy consumption amount of an air conditioner. The idle electric energy yield is a difference between the electric energy yield of the photovoltaic array and the electric energy consumption amount of the energy storage device and the load. The electric energy yield of the photovoltaic array, the electric energy consumption amount of the load, and the electric energy consumption amount of the energy storage device need to be obtained, to obtain the idle electric energy yield of the photovoltaic power generation system.

Optionally, the electric energy yield of the photovoltaic array may be estimated based on light intensity, or measured by using an electricity meter. This is not limited herein.

Optionally, the idle electric energy yield of the photovoltaic power generation system may be measured by using an idle generated power. A photovoltaic generated power and a consumed power are obtained, the consumed power includes a consumed power of the load and a charging power of the energy storage device, and the consumed power may be subtracted from the photovoltaic generated power to obtain the idle generated power of the photovoltaic power generation system.

Optionally, the photovoltaic power generation system may periodically obtain the battery temperature and the idle electric energy yield based on preset duration.

302. Determine whether the battery temperature is less than or equal to a low-temperature threshold.

It is determined, based on the obtained battery temperature, whether the battery temperature is less than or equal to the preset low-temperature threshold. A service life and performance of the battery are affected when the temperature is excessively low. When the temperature is less than −20° C., the service life of the battery decreases. When the battery temperature is less than 5° C., the performance deteriorates. Therefore, the low-temperature threshold for operating of the battery may be preset, and a specific value of the low-temperature threshold is not limited in this embodiment. The low-temperature threshold is an empirical value determined based on a characteristic of the battery in the energy storage device in actual application. This is not specifically limited herein. Similarly, in the following embodiments, there may be a high-temperature threshold, a first high-temperature threshold, a second high-temperature threshold, a third high-temperature threshold, and a fourth high-temperature threshold, and all of the thresholds are empirical values determined based on the characteristic of the battery. “First”, “second”, “third”, and “fourth” are merely used to distinguish between different temperature thresholds.

Optionally, for example, the low-temperature threshold may be set to a range from 5° C. to 10° C. If the obtained battery temperature is 3° C., it is determined that the battery temperature is less than the low-temperature threshold, or if the battery temperature is 25° C., it is determined that the battery temperature is greater than the low-temperature threshold.

It should be noted that step 302 is an optional step, and may or may not be performed. This is not limited herein.

303. If the battery temperature is greater than the low-temperature threshold, determine whether the idle electric energy yield is greater than zero.

If it is determined, in step 302, that the battery temperature is greater than the preset low-temperature threshold, it is determined whether the idle electric energy yield is greater than zero.

The idle electric energy yield may be calculated based on the electric energy yield of the photovoltaic array, the electric energy consumption amount of the load, and the electric energy consumption amount of the energy storage device that are obtained. Optionally, the idle electric energy yield of the photovoltaic power generation system may be measured by using the idle generated power. The photovoltaic generated power and the consumed power are obtained, the consumed power includes the consumed power of the load and the charging power of the energy storage device, and the consumed power may be subtracted from the photovoltaic generated power to obtain the idle generated power of the photovoltaic power generation system. If the photovoltaic generated power is greater than the consumed power, the idle electric energy yield is greater than zero. In this case, because there is a surplus of an electric energy yield of a photovoltaic power generation system, a light discarding phenomenon occurs, leading to a waste of electric energy. If the photovoltaic generated power is equal to the consumed power, it is determined that the idle electric energy yield is equal to zero.

It may be understood that when the electric energy yield of the photovoltaic array is less than the electric energy consumption amount of the load and the electric energy consumption amount of the energy storage device, the consumed power of the load and the consumed power of the energy storage device may be reduced, or the energy storage device may be powered down. In this case, it may be considered that the idle electric energy yield is less than zero.

For example, if the current photovoltaic generated power is 60 kilowatts (KW), the consumed power of the load is 10 KW, and the charging power of the energy storage device is 30 KW, the idle generated power is 20 KW. If the current photovoltaic generated power is 60 KW, the consumed power of the load is 30 KW, and the charging power of the energy storage device is 30 KW, the idle generated power is 0.

304. If the battery temperature is greater than the low-temperature threshold and the idle electric energy yield is greater than zero, determine that a refrigeration temperature is a first target temperature.

The refrigerating device in the energy storage device may control a temperature, for example, an air temperature inside a battery energy storage cabinet is reduced by using an air conditioner, to control the battery temperature by controlling a temperature of an environment in which the battery is located. The first target temperature is an empirical value determined based on a characteristic of the battery in the energy storage device in actual application. This is not specifically limited herein. Similarly, in the following embodiments, there may be a second target temperature, a third target temperature, a fourth target temperature, a fifth target temperature, a sixth target temperature, a seventh target temperature, and an eighth target temperature, and all of the target temperatures are empirical values determined based on the characteristic of the battery. “First”, “second”, “third”, “fourth”, “fifth”, “sixth”, “seventh”, and “eighth” are merely used to distinguish between different target temperatures. It may be understood that the first target temperature, the second target temperature, the third target temperature, the fourth target temperature, the fifth target temperature, the sixth target temperature, the seventh target temperature, and the eighth target temperature should fall within an appropriate operating temperature range of the battery.

If it is determined, in step 303, that the idle electric energy yield is greater than zero, it may be directly determined that the refrigeration temperature is the preset first target temperature, for example, 10° C.

There are a plurality of manners of determining, based on the battery temperature of the energy storage device and/or the idle electric energy yield, that the refrigeration temperature is the first target temperature. Description is separately provided below.

Optionally, if the battery temperature is greater than the low-temperature threshold and the idle electric energy yield is greater than zero, it is determined, based on the idle electric energy yield, that the refrigeration temperature is the first target temperature. The idle electric energy yield is negatively correlated with the first target temperature. In other words, a higher idle electric energy yield indicates a lower first target temperature. It may be understood that a lower limit value of the first target temperature should fall within an appropriate operating temperature range of the battery.

Optionally, if the battery temperature is greater than the low-temperature threshold and the idle electric energy yield is greater than zero, it is determined, based on the battery temperature, that the refrigeration temperature is the first target temperature. The battery temperature is negatively correlated with the first target temperature. In other words, a higher battery temperature indicates a lower first target temperature. Setting a relatively low refrigeration temperature can quickly decrease the battery temperature, to fully utilize the idle electric energy yield. It may be understood that the first target temperature should fall within an appropriate operating temperature range of the battery.

Optionally, if the battery temperature is greater than the low-temperature threshold and the idle electric energy yield is greater than zero, it is determined, based on the battery temperature and the idle electric energy yield, that the refrigeration temperature is the first target temperature. The idle electric energy yield is negatively correlated with the first target temperature, and the battery temperature is negatively correlated with the first target temperature. A specific algorithm of determining the first target temperature based on the idle electric energy yield and the battery temperature is not limited herein. It may be understood that the first target temperature should fall within an appropriate operating temperature range of the battery.

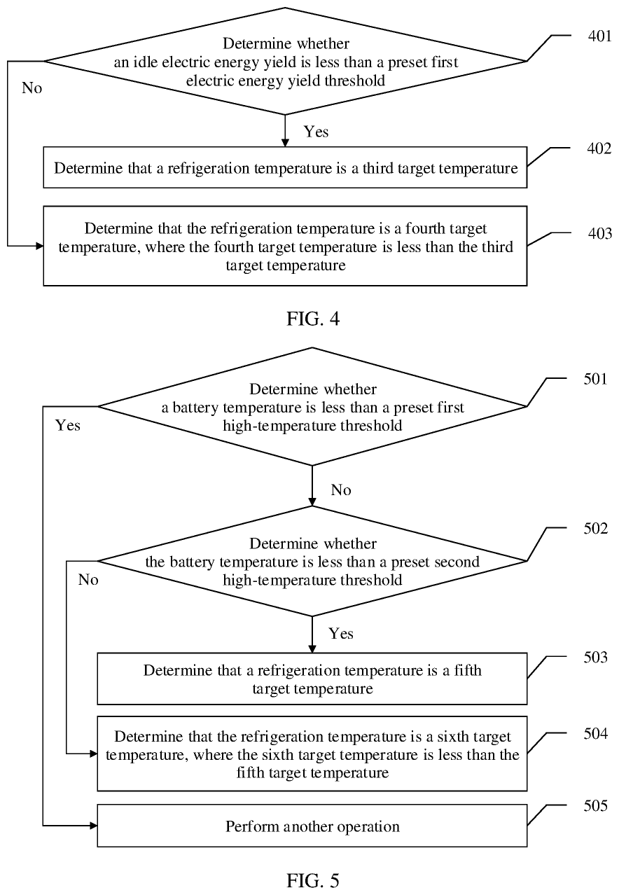

Optionally, referring to FIG. 4 and FIG. 5, two specific implementations of determining, based on the battery temperature of the energy storage device and/or the idle electric energy yield, that the refrigeration temperature is the first target temperature are respectively described.

1. Refer to FIG. 4:

401. Determine whether the idle electric energy yield is less than a preset first threshold.

If the idle electric energy yield is greater than zero, it may further be determined whether the idle electric energy yield is less than the preset first threshold. The first threshold is a positive number, and a specific value is not limited herein.

Optionally, it may be determined whether the idle generated power is less than the preset first threshold.

402. If the idle electric energy yield is less than the preset first threshold, determine that the refrigeration temperature is the third target temperature.

If the idle electric energy yield is less than the preset first threshold, it is determined that the refrigeration temperature is the third target temperature.

For example, if the first threshold is 10 KW, and the idle generated power is 8 KW, it is determined that the refrigeration temperature, namely, the third target temperature, is 20° C.

403. If the idle electric energy yield is greater than or equal to the preset first threshold, determine that the refrigeration temperature is the fourth target temperature, where the fourth target temperature is less than the third target temperature.

If the idle electric energy yield is less than the preset first threshold, it is determined that the refrigeration temperature is the fourth target temperature. The fourth target temperature is less than the third target temperature.

For example, if the first threshold is 10 KW, and the idle generated power is 15 KW, it may be determined that the refrigeration temperature, namely, the fourth target temperature, is 15° C.

2. Refer to FIG. 5:

501. Determine whether the battery temperature is less than the preset first high-temperature threshold.

If the idle electric energy yield is greater than zero, it may further be determined whether the battery temperature is less than the preset first high-temperature threshold. A value of the first high-temperature threshold is not limited herein, and for example, may be 25° C.

502. If the battery temperature is greater than or equal to the preset first high-temperature threshold, determine whether the battery temperature is less than the preset second high-temperature threshold.

If it is determined, in step 501, that the battery temperature is greater than or equal to the preset first high-temperature threshold, it is determined whether the battery temperature is less than the preset second high-temperature threshold. A value of the second high-temperature threshold is not limited herein, and for example, may be 35° C.

503. If the battery temperature is greater than or equal to the first high-temperature threshold and less than the second high-temperature threshold, determine that the refrigeration temperature is the fifth target temperature.

If the battery temperature is greater than or equal to the first high-temperature threshold and less than the second high-temperature threshold, it is determined that the refrigeration temperature is the fifth target temperature. A specific value of the fifth target temperature is not limited herein, and for example, may be 20° C.

For example, if the first high-temperature threshold is 25° C., the second high-temperature threshold is 35° C., and the battery temperature is 30° C., it is determined that the refrigeration temperature, namely, the fifth target temperature, is 20° C.

504. If the battery temperature is greater than or equal to the second high-temperature threshold, determine that the refrigeration temperature is the sixth target temperature, where the sixth target temperature is less than the fifth target temperature.

If the battery temperature is greater than or equal to the second high-temperature threshold, it is determined that the refrigeration temperature is the sixth target temperature. The sixth target temperature is less than the fifth target temperature. A specific value of the sixth target temperature is not limited herein, and for example, may be 15° C.

For example, if the second high-temperature threshold is 35° C. and the battery temperature is 40° C., it is determined that the refrigeration temperature, namely, the sixth target temperature, is 15° C.

505. If the battery temperature is less than the first high-temperature threshold, perform another operation.

If the battery temperature is less than the first high-temperature threshold, another operation is performed. For example, the refrigerating device may be turned off, or a frequency of obtaining the battery temperature is increased, that is, monitoring on the battery temperature is enhanced. A specific operation manner is not limited herein.

The foregoing describes the plurality of possible implementations of determining, based on the battery temperature of the energy storage device and/or the idle electric energy yield, that the refrigeration temperature is the first target temperature. During application, a specific implementation may be determined based on an actual status. This is not limited herein.

305. If the battery temperature is greater than the low-temperature threshold, and the idle electric energy yield is less than or equal to zero, determine, based on the battery temperature, that the refrigeration temperature is the second target temperature or turn off the refrigerating device based on the battery temperature.

If it is determined, in step 303, that the idle electric energy yield is less than or equal to zero, it is determined, based on the battery temperature, that the refrigeration temperature is the second target temperature or the refrigerating device is turned off based on the battery temperature. The second target temperature is greater than the first target temperature, and a specific value of the second target temperature is not limited herein.

When the battery temperature is greater than the low-temperature threshold, and the idle electric energy yield is less than or equal to zero, there are a plurality of implementations of determining, based on the battery temperature, that the refrigeration temperature is the second target temperature. Description is separately provided below.

Optionally, if the battery temperature is greater than or equal to a preset high-temperature threshold, it is determined, based on the battery temperature, that the refrigeration temperature is the second target temperature, where the second target temperature is positively correlated with the battery temperature. Because the idle electric energy yield is less than or equal to zero, in other words, there is no idle electric energy in the photovoltaic power generation system, and when the battery temperature is greater than or equal to the preset high-temperature threshold, the second target temperature is positively correlated with the battery temperature, electric energy consumption can be reduced when the battery temperature is controlled.

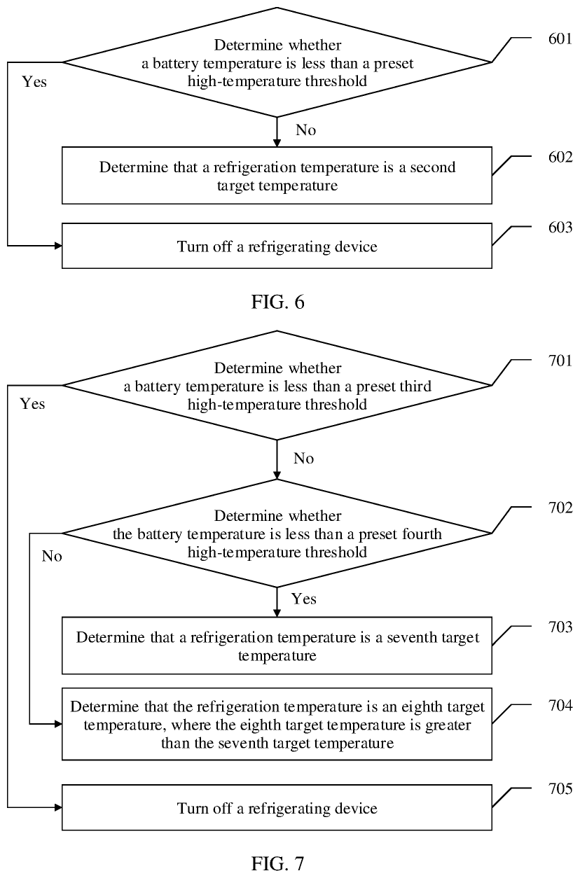

Optionally, referring to FIG. 6 and FIG. 7, two specific implementations of determining, based on the battery temperature, that the refrigeration temperature is the second target temperature are respectively described.

1. FIG. 6 is a schematic diagram of another embodiment of an energy storage device temperature control method. An implementation of determining, based on the battery temperature, that the refrigeration temperature is the second target temperature is described.

601. Determine whether the battery temperature is less than the preset high-temperature threshold.

It is determined whether the battery temperature is less than the preset high-temperature threshold. A specific value of the high-temperature threshold is not limited herein. It may be understood that the high-temperature threshold is greater than the preset low-temperature threshold.

602. If the battery temperature is greater than or equal to the preset high-temperature threshold, determine that the refrigeration temperature is the second target temperature.

If the battery temperature is greater than or equal to the preset high-temperature threshold, it is determined that the refrigeration temperature is the second target temperature. The second target temperature is greater than the first target temperature. For example, the high-temperature threshold is 35° C., the first target temperature is 10° C., and the second target temperature is 25° C. If the battery temperature is 40° C., greater than the high-temperature threshold 35° C., it is determined that the refrigeration temperature is the second target temperature 25° C.

603. If the battery temperature is less than the preset high-temperature threshold, turn off the refrigerating device.

If the battery temperature is less than the preset high-temperature threshold, the refrigerating device is turned off.

For example, the high-temperature threshold is 35° C., the first target temperature is 10° C., and the second target temperature is 25° C. If the battery temperature is 28° C., the refrigerating device is turned off. When the battery temperature is less than the preset high-temperature threshold, the refrigerating device is turned off, to reduce electric energy consumption.

2. FIG. 7 is a schematic diagram of another embodiment of an energy storage device temperature control method. Another implementation of determining, based on the battery temperature, that the refrigeration temperature is the second target temperature is described.

701. Determine whether the battery temperature is less than the preset third high-temperature threshold.

It is determined whether the battery temperature is less than the preset third high-temperature threshold. A specific value of the third high-temperature threshold is not limited, and the third high-temperature threshold may be, for example, 30° C.

702. If the battery temperature is greater than or equal to the third high-temperature threshold, determine whether the battery temperature is less than the preset fourth high-temperature threshold.

If the battery temperature is greater than or equal to the third high-temperature threshold, it is determined whether the battery temperature is less than the preset fourth high-temperature threshold. A specific value of the fourth high-temperature threshold is not limited, and the fourth high-temperature threshold may be, for example, 40° C.

703. If the battery temperature is greater than or equal to the third high-temperature threshold and less than the preset fourth high-temperature threshold, determine that the refrigeration temperature is the seventh target temperature.

If the battery temperature is greater than or equal to the third high-temperature threshold and less than the preset fourth high-temperature threshold, it is determined that the refrigeration temperature is the seventh target temperature. A specific value of the seventh target temperature is not limited.

For example, the third high-temperature threshold is 30° C., the fourth high-temperature threshold is 40° C., and the seventh target temperature is 25° C. If the battery temperature is 36° C., greater than 30° C. and less than 40° C., it is determined that the refrigeration temperature, namely, the seventh target temperature, is 25° C.

704. If the battery temperature is greater than or equal to the preset fourth high-temperature threshold, determine that the refrigeration temperature is the eighth target temperature, where the eighth target temperature is greater than the seventh target temperature.

If the battery temperature is greater than or equal to the preset fourth high-temperature threshold, it is determined that the refrigeration temperature is the eighth target temperature. The eighth target temperature is greater than the seventh target temperature, and a specific value of the eighth target temperature is not limited.

For example, the third high-temperature threshold is 30° C., the fourth high-temperature threshold is 40° C., and the eighth target temperature is 33° C. If the battery temperature is 43° C., greater than 40° C., it is determined that the refrigeration temperature, namely, the eighth target temperature, is 33° C.

705. If the battery temperature is less than the preset third high-temperature threshold, turn off the refrigerating device.

If the battery temperature is less than the preset third high-temperature threshold, the refrigerating device is turned off.

For example, the third high-temperature threshold is 30° C. If the battery temperature is 28° C., the refrigerating device is turned off, to save electric energy.

The foregoing describes the plurality of possible implementations of determining, based on the battery temperature, that the refrigeration temperature is the second target temperature. During application, a specific implementation may be determined based on an actual status. This is not limited herein.

306. If the battery temperature is less than or equal to the low-temperature threshold, turn off the refrigerating device.

If it is determined, in step 302, that the battery temperature is less than or equal to the low-temperature threshold, the refrigerating device is turned off. It may be understood that when the battery temperature is less than or equal to the low-temperature threshold, the battery temperature is relatively low, and the refrigerating device is not needed for cooling.

For example, the preset low-temperature threshold is 5° C. If the battery temperature is 3° C., the refrigerating device is turned off.

According to the energy storage device temperature control method in this embodiment of this application, the refrigeration temperature may be comprehensively determined based on the battery temperature and the idle electric energy yield. When the idle electric energy yield is greater than zero, a relatively low refrigeration temperature may be determined, to fully utilize electric energy and reduce an amount of discarded photovoltaic energy. Compared with a case of determining, based only on a battery temperature, whether to perform refrigeration, utilization of electricity generated by the photovoltaic power generation apparatus can be improved.

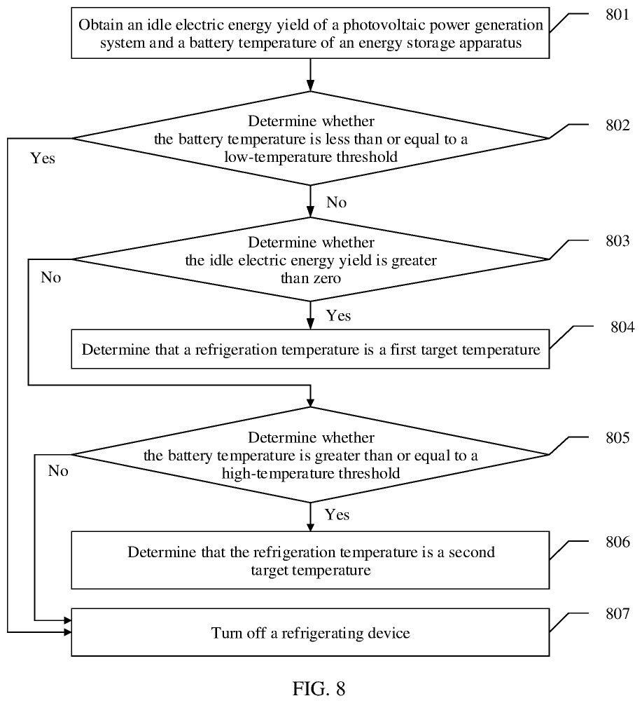

For ease of understanding the solutions in the embodiments of this application, FIG. 8 is a schematic diagram of an energy storage device temperature control method according to an embodiment of this application.

The energy storage device temperature control method in this embodiment of this application is as follows:

801. Obtain an idle electric energy yield of a photovoltaic power generation system and a battery temperature of an energy storage device.

802. Determine whether the battery temperature is less than or equal to a low-temperature threshold.

803. If the battery temperature is greater than the low-temperature threshold, determine whether the idle electric energy yield is greater than zero.

804. If the battery temperature is greater than the low-temperature threshold and the idle electric energy yield is greater than zero, determine that a refrigeration temperature is a first target temperature.

805. If the battery temperature is greater than the low-temperature threshold and the idle electric energy yield is less than or equal to zero, determine whether the battery temperature is greater than or equal to a high-temperature threshold, where the high-temperature threshold is greater than the low-temperature threshold.

806. If the battery temperature is greater than or equal to the high-temperature threshold and the idle electric energy yield is less than or equal to zero, determine that the refrigeration temperature is a second target temperature, where the second target temperature is greater than the first target temperature.

807. If the battery temperature is greater than the low-temperature threshold, or if the battery temperature is greater than the low-temperature threshold and less than the high-temperature threshold, and the idle electric energy yield is less than or equal to zero, turn off a refrigerating device.

For example, the preset low-temperature threshold is 5° C., and the high-temperature threshold is 35° C. The first target temperature is preset to 10° C., and the second target temperature is preset to 25° C.

### EXAMPLE 1

If the obtained battery temperature is 3° C., less than the preset low-temperature threshold, the refrigerating device is turned off.

### EXAMPLE 2

If the obtained battery temperature is 25° C., and the idle electric energy yield is greater than zero, because the battery temperature is greater than the low-temperature threshold and the idle electric energy yield is greater than zero, it is determined that the refrigeration temperature is the first target temperature 10° C.

### EXAMPLE 3

If the obtained battery temperature is 30° C., and the idle electric energy yield is zero, because the battery temperature is greater than the low-temperature threshold and less than the high-temperature threshold, and the idle electric energy yield is zero, the refrigerating device is turned off.

### EXAMPLE 4

If the obtained battery temperature is 40° C., and the idle electric energy yield is zero, because the battery temperature is greater than the high-temperature threshold and the idle electric energy yield is zero, it is determined that the refrigeration temperature is the second target temperature 25° C.

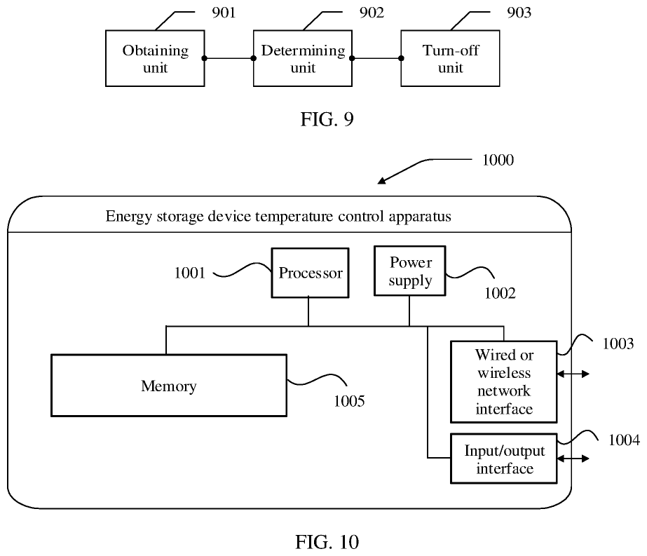

The foregoing describes the energy storage device temperature control method according to some embodiments. The following describes a device performing the method. FIG. 9 is a schematic diagram of an energy storage device temperature control apparatus according to an embodiment of this application.

In actual application, the energy storage device temperature control apparatus may be an independent device, or may be a central control unit integrated into a photovoltaic power generation system. This is not specifically limited herein.

The energy storage device temperature control apparatus in this embodiment of this application includes:

an obtaining unit 901, configured to obtain an idle electric energy yield of a photovoltaic power generation system and a battery temperature of an energy storage device, where the photovoltaic power generation system includes a photovoltaic array, the energy storage device, and a load, the energy storage device includes a refrigerating device and a battery, and the idle electric energy yield is a difference between an electric energy yield of the photovoltaic array and an electric energy consumption amount of the energy storage device and the load; and

a determining unit 902, configured to determine a refrigeration temperature of the refrigerating device based on the idle electric energy yield and the battery temperature, where the refrigerating device is used to control a temperature of the battery.

The determining unit 902 is configured to:

if the idle electric energy yield is greater than zero, determine that the refrigeration temperature is a first target temperature, or determine, based on the battery temperature of the energy storage device and/or the idle electric energy yield, that the refrigeration temperature is the first target temperature; or if the idle electric energy yield is less than or equal to zero, determine, based on the battery temperature, that the refrigeration temperature is a second target temperature or turn off the refrigerating device based on the battery temperature, where the second target temperature is greater than the first target temperature.

The determining unit 902 is configured to:

determine, based on the idle electric energy yield, that the refrigeration temperature is the first target temperature, where the idle electric energy yield is negatively correlated with the first target temperature; or determine, based on the battery temperature, that the refrigeration temperature is the first target temperature, where the battery temperature is negatively correlated with the first target temperature; or determine, based on the battery temperature and the idle electric energy yield, that the refrigeration temperature is the first target temperature, where the idle electric energy yield is negatively correlated with the first target temperature, and the battery temperature is negatively correlated with the first target temperature.

The determining unit 902 is configured to:

if the idle electric energy yield is greater than zero and less than a preset first threshold, determine that the refrigeration temperature is a third target temperature, where the first threshold is greater than zero, and the third target temperature is less than the second target temperature; or if the idle electric energy yield is greater than or equal to the first threshold, determine that the refrigeration temperature is a fourth target temperature, where the fourth target temperature is less than the third target temperature.

The determining unit 902 is configured to:

if the battery temperature is greater than or equal to a preset first high-temperature threshold and less than a preset second high-temperature threshold, determine that the refrigeration temperature is a fifth target temperature, where the second high-temperature threshold is greater than the first high-temperature threshold; or if the battery temperature is greater than the second high-temperature threshold, determine that the refrigeration temperature is a sixth target temperature, where the sixth target temperature is less than the fifth target temperature.

The determining unit 902 is configured to:

if the battery temperature is greater than or equal to a preset high-temperature threshold, determine that the refrigeration temperature is the second target temperature; or if the battery temperature is less than the high-temperature threshold, turn off the refrigerating device.

The determining unit 902 is configured to:

determine, based on the battery temperature, that the refrigeration temperature is the second target temperature, where the second target temperature is positively correlated with the battery temperature.

The determining unit 902 is configured to:

if the battery temperature is greater than or equal to a preset third high-temperature threshold and less than a preset fourth high-temperature threshold, determine that the refrigeration temperature is a seventh target temperature, where the fourth high-temperature threshold is greater than the third high-temperature threshold, and the seventh target temperature is greater than the first target temperature; or if the battery temperature is greater than or equal to the fourth high-temperature threshold, determine that the refrigeration temperature is an eighth target temperature, where the eighth target temperature is greater than the seventh target temperature.

The apparatus further includes:

a turn-off unit 903, configured to: if the battery temperature is less than or equal to a preset low-temperature threshold, turn off the refrigerating device, where the low-temperature threshold is less than any one of the first high-temperature threshold, the third high-temperature threshold, and the high-temperature threshold.

The obtaining unit 901 is configured to:

obtain a photovoltaic generated power and a consumed power, where the consumed power includes a consumed power of the load and a charging power of the battery; and the determining unit 902 is further configured to determine the idle electric energy yield based on a difference between the photovoltaic generated power and the consumed power.

FIG. 10 is a schematic diagram of an energy storage device temperature control apparatus 1000 according to an embodiment of this application.

The apparatus 1000 for controlling a temperature of an energy storage device may differ greatly based on different configurations or performance, and may include one or more processors 1001 and a memory 1005, and the memory 1005 stores a program or data.

The memory 1005 may be a volatile memory or a non-volatile memory. The processor 1001 may communicate with the memory 1005, and execute a series of instructions in the memory 1005 on the apparatus 1000 for controlling a temperature of an energy storage device.

The apparatus 1000 for controlling a temperature of an energy storage device may further include one or more power supplies 1002, one or more wired or wireless network interfaces 1003, and one or more input/output interfaces 1004.

For a process executed by the processor 1001 in the apparatus 1000 for controlling a temperature of an energy storage device in this embodiment, refer to the method process described in the foregoing method embodiment.

It may be clearly understood by a person skilled in the art that, for the purpose of convenient and brief description, for a detailed working process of the foregoing system, apparatus, and unit, a corresponding process in the foregoing method embodiments may be referred to.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the prior art, or all or some of the technical solutions may be implemented in the form of a software product. The computer software product is stored in a storage medium and includes several instructions for instructing a computer device (which may be a personal computer, a server, or a network device) to perform all or some of the steps of the methods described in the embodiments of this application. The foregoing storage medium includes: any medium that can store program code, such as a USB flash drive, a removable hard disk, a read-only memory (ROM), a random access memory (RAM), a magnetic disk, or an optical disc.

The foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of this application.

What is claimed is:

1. An energy storage device temperature control method, comprising:
obtaining an idle electric energy yield of a photovoltaic power generation system and a battery temperature of a battery of an energy storage device, wherein the photovoltaic power generation system comprises a photovoltaic array, the energy storage device, and a load, wherein the energy storage device comprises a refrigerating device and the battery, and wherein the idle electric energy yield is a difference between an electric energy yield of the photovoltaic array and an electric energy consumption amount of the energy storage device and the load;
determining a refrigeration temperature of the refrigerating device based on the idle electric energy yield and the battery temperature; and
controlling a temperature of the battery by using the refrigerating device at least in accordance with the determined refrigeration temperature.

2. The method according to claim 1, wherein the determining a refrigeration temperature of the refrigerating device based on the idle electric energy yield and the battery temperature comprises:
if the idle electric energy yield is greater than zero, determining, based on the battery temperature and/or the idle electric energy yield, that the refrigeration temperature is a first target temperature; or
if the idle electric energy yield is less than or equal to zero, determining, based on the battery temperature, that the refrigeration temperature is a second target temperature, or turning off the refrigerating device based on the battery temperature, wherein the second target temperature is greater than the first target temperature.

3. The method according to claim 2, wherein the idle electric energy yield is greater than zero, and wherein the determining, based on the battery temperature and/or the idle electric energy yield, that the refrigeration temperature is a first target temperature comprises:
determining, based on the idle electric energy yield, that the refrigeration temperature is the first target temperature, wherein the idle electric energy yield is negatively correlated with the first target temperature;
determining, based on the battery temperature, that the refrigeration temperature is the first target temperature, wherein the battery temperature is negatively correlated with the first target temperature; or
determining, based on the battery temperature and the idle electric energy yield, that the refrigeration temperature is the first target temperature, wherein the idle electric energy yield is negatively correlated with the first target temperature, and the battery temperature is negatively correlated with the first target temperature.

4. The method according to claim 2, wherein the determining, based on the battery temperature and/or the idle electric energy yield, that the refrigeration temperature is a first target temperature comprises:
if the idle electric energy yield is greater than zero and less than a preset first threshold, determining that the refrigeration temperature is a third target temperature, wherein the preset first threshold is greater than zero, and the third target temperature is less than the second target temperature; or
if the idle electric energy yield is greater than or equal to the preset first threshold, determining that the refrigeration temperature is a fourth target temperature, wherein the fourth target temperature is less than the third target temperature.

5. The method according to claim 2, wherein the determining, based on the battery temperature and/or the idle electric energy yield, that the refrigeration temperature is a first target temperature comprises:
if the battery temperature is greater than or equal to a preset first high-temperature threshold and less than a preset second high-temperature threshold, determining that the refrigeration temperature is a fifth target temperature, wherein the preset second high-temperature threshold is greater than the preset first high-temperature threshold; or
if the battery temperature is greater than or equal to the preset second high-temperature threshold, determining that the refrigeration temperature is a sixth target temperature, wherein the sixth target temperature is less than the fifth target temperature.

6. The method according to claim 2, wherein the determining, based on the battery temperature, that the refrigeration temperature is a second target temperature, or turning off the refrigerating device based on the battery temperature comprises:
if the battery temperature is greater than or equal to a preset high-temperature threshold, determining that the refrigeration temperature is the second target temperature; or
if the battery temperature is less than the preset high-temperature threshold, turning off the refrigerating device.

7. The method according to claim 6, wherein the if the battery temperature is greater than or equal to a preset high-temperature threshold, determining that the refrigeration temperature is the second target temperature comprises:
determining, based on the battery temperature, that the refrigeration temperature is the second target temperature, wherein the second target temperature is positively correlated with the battery temperature.

8. The method according to claim 6, wherein the if the battery temperature is greater than or equal to a preset high-temperature threshold, determining that the refrigeration temperature is the second target temperature comprises:
if the battery temperature is greater than or equal to a preset third high-temperature threshold and less than a preset fourth high-temperature threshold, determining that the refrigeration temperature is a seventh target temperature, wherein the preset fourth high-temperature threshold is greater than the preset third high-temperature threshold, and the seventh target temperature is greater than the first target temperature; or
if the battery temperature is greater than or equal to the preset fourth high-temperature threshold, determining that the refrigeration temperature is an eighth target temperature, wherein the eighth target temperature is greater than the seventh target temperature.

9. The method according to claim 8, wherein the method further comprises:
if the battery temperature is less than or equal to a preset low-temperature threshold, turning off the refrigerating device, wherein the preset low-temperature threshold is less than any one of the preset third high-temperature threshold and the preset high-temperature threshold.

10. The method according to claim 1, wherein the obtaining an idle electric energy yield of a photovoltaic power generation system comprises:
obtaining a photovoltaic generated power and a consumed power, wherein the consumed power comprises a consumed power of the load and a charging power of the battery; or
determining the idle electric energy yield based on a difference between the photovoltaic generated power and the consumed power.

11. An energy storage device temperature control apparatus, comprising:
an obtaining unit, configured to obtain an idle electric energy yield of a photovoltaic power generation system and a battery temperature of a battery of an energy storage device, wherein the photovoltaic power generation system comprises a photovoltaic array, the energy storage device, and a load, wherein the energy storage device comprises a refrigerating device and the battery, and wherein the idle electric energy yield is a difference between an electric energy yield of the photovoltaic array and an electric energy consumption amount of the energy storage device and the load; and
a determining unit, configured to determine a refrigeration temperature of the refrigerating device based on the idle electric energy yield and the battery temperature, wherein the refrigerating device is used to control a temperature of the battery in accordance with the determined refrigeration temperature.

12. The apparatus according to claim 11, wherein the determining unit is configured to:
if the idle electric energy yield is greater than zero, determine, based on the battery temperature and/or the idle electric energy yield, that the refrigeration temperature is the first target temperature; or
if the idle electric energy yield is less than or equal to zero, determine, based on the battery temperature, that the refrigeration temperature is a second target temperature or turn off the refrigerating device based on the battery temperature, wherein the second target temperature is greater than the first target temperature.

13. The apparatus according to claim 12, wherein the idle electric energy yield is greater than zero, and wherein the determining unit is specifically configured to:
determine, based on the idle electric energy yield, that the refrigeration temperature is the first target temperature, wherein the idle electric energy yield is negatively correlated with the first target temperature;
determine, based on the battery temperature, that the refrigeration temperature is the first target temperature, wherein the battery temperature is negatively correlated with the first target temperature; or
determine, based on the battery temperature and the idle electric energy yield, that the refrigeration temperature is the first target temperature, wherein the idle electric energy yield is negatively correlated with the first target temperature, and the battery temperature is negatively correlated with the first target temperature.

14. The apparatus according to claim 12, wherein the determining unit is specifically configured to:
if the idle electric energy yield is greater than zero and less than a preset first threshold, determine that the refrigeration temperature is a third target temperature, wherein the first threshold is greater than zero, and the third target temperature is less than the second target temperature; or
if the idle electric energy yield is greater than or equal to the first threshold, determine that the refrigeration temperature is a fourth target temperature, wherein the fourth target temperature is less than the third target temperature.

15. The apparatus according to claim 12, wherein the determining unit is configured to:
if the battery temperature is greater than or equal to a preset first high-temperature threshold and less than a preset second high-temperature threshold, determine that the refrigeration temperature is a preset fifth target temperature, wherein the preset second high-temperature threshold is greater than the first high-temperature threshold; or
if the battery temperature is greater than or equal to the preset second high-temperature threshold, determine that the refrigeration temperature is a sixth target temperature, wherein the sixth target temperature is less than the fifth target temperature.

16. The apparatus according to claim 12, wherein the determining unit is configured to:
if the battery temperature is greater than or equal to a preset high-temperature threshold, determine that the refrigeration temperature is the second target temperature; or
if the battery temperature is less than the preset high-temperature threshold, turn off the refrigerating device.

17. The apparatus according to claim 16, wherein the determining unit is configured to:
determine, based on the battery temperature, that the refrigeration temperature is the second target temperature, wherein the second target temperature is positively correlated with the battery temperature.

18. The apparatus according to claim 16, wherein the determining unit is specifically configured to:
if the battery temperature is greater than or equal to a preset third high-temperature threshold and less than a preset fourth high-temperature threshold, determine that the refrigeration temperature is a seventh target temperature, wherein the preset fourth high-temperature threshold is greater than the preset third high-temperature threshold, and the seventh target temperature is greater than the first target temperature; or
if the battery temperature is greater than or equal to the preset fourth high-temperature threshold, determine that the refrigeration temperature is an eighth target temperature, wherein the eighth target temperature is greater than the seventh target temperature.

19. The apparatus according to claim 11, wherein the apparatus further comprises:
a turn-off unit, configured to: if the battery temperature is less than or equal to a preset low-temperature threshold, turn off the refrigerating device, wherein the low-temperature threshold is less than any one of a first high-temperature threshold, a third high-temperature threshold, and a high-temperature threshold.

20. The apparatus according to claim 11, wherein the obtaining unit is specifically configured to:
obtain a photovoltaic generated power and a consumed power, wherein the consumed power comprises a consumed power of the load and a charging power of the battery; and
the determining unit is further configured to determine the idle electric energy yield based on a difference between the photovoltaic generated power and the consumed power.
